(19) United States
(12) Patent Application Publication
(10) Pub. No.: US 2020/0395796 A1
(43) Pub. Date: Dec. 17, 2020

(54) Rotor for Motor for Reducing Amount of Usage of Permanent Magnets

(71) Applicant: Komotek Co., Ltd., Seongnam-si (KR)

(72) Inventors: Deok Geun Kim, Seongnam-si (KR); Yun Yong Song, Seongnam-si (KR)

(21) Appl. No.: 16/543,735

(22) Filed: Aug. 19, 2019

(30) Foreign Application Priority Data
Jun. 17, 2019 (KR) 10-2019-0071844

(51) Int. Cl. H02K 1/27

(52) U.S. Cl. CPC H02K 1/276; H02K 2213/03

(57) ABSTRACT

Disclosed is a rotor for a motor for reducing the amount of usage of permanent magnets, in which a rotor structure in which multiple multilayered permanent magnets are embedded has a vacant space in which no permanent magnet is embedded, such that the amount of usage of the permanent magnets is reduced, and an output, torque, and efficiency of the motor are improved by using the space in which no permanent magnet is embedded. The present invention has an effect in that the amount of usage of the permanent magnets is markedly reduced during a process of manufacturing the motor, such that material costs are reduced, working time required to embed the permanent magnets is reduced, working time is greatly reduced, costs are reduced, the number of working processes is reduced, and assembly workability is improved.

### CROSS-REFERENCE TO RELATED APPLICATION

This application claims priority to Korean Patent Application No. 10-2019-0071844 filed Jun. 17, 2019, the disclosure of which is hereby incorporated by reference in its entirety.

### TECHNICAL FIELD

The present invention relates to a rotor for a motor, and particularly, to a rotor for a motor for reducing the amount of usage of permanent magnets, in which a rotor structure in which multiple multilayered permanent magnets are embedded has a vacant space in which no permanent magnet is embedded, such that the amount of usage of the permanent magnets is reduced, and an output, torque, and efficiency of the motor are improved by using the space in which no permanent magnet is embedded.

### BACKGROUND

A motor for an electric vehicle has a rotor structure in which multiple multilayered permanent magnets are embedded to implement low-speed/high torque, high efficiency, and high-speed performance. That is, the material cost of the permanent magnets is equal to or more than 80% of the material cost of the motor.

Therefore, in the case in which the motor uses the multiple multilayered permanent magnets, there is a problem in that material costs are increased because a large number of high-priced permanent magnets are used.

Because the multilayered permanent magnets are embedded in the motor, a large amount of working time is required to embed the multiple permanent magnets during a manufacturing process, which causes difficulty in manufacturing the motor and causes an increase in prices.

### Document Of Related Art

### Patent Document

(Patent Document 1) Korean Patent No. 10-0548716

### SUMMARY

The present invention has been made in an effort to solve the above-mentioned problems, and an object of the present invention is to provide a rotor for a motor for reducing the amount of usage of permanent magnets, in which a rotor structure in which multiple multilayered permanent magnets are embedded has a vacant space in which no permanent magnet is embedded, such that the amount of usage of the permanent magnets is reduced, and an output, torque, and efficiency of the motor are improved by using the space in which no permanent magnet is embedded.

An exemplary embodiment of the present invention provides a rotor for a motor for reducing the amount of usage of permanent magnets, the rotor being disposed in a stator and having one or more permanent magnets disposed in multiple layers so that motor poles are alternately disposed to define N-pole magnets and S-pole magnets, wherein the multiple layers include: a first layer in which first permanent magnets and second permanent magnets are provided in a V shape and spaced apart from a central axis at a predetermined distance; and a second layer in which third permanent magnets are arranged in a first direction from the central axis, fourth permanent magnets are arranged in a second direction from the central axis, permanent magnet embedding grooves are formed in a horizontal direction between ends of the third permanent magnets and ends of the fourth permanent magnets, the permanent magnet embedding grooves are vacant spaces in which no permanent magnet is embedded, and the third permanent magnets, the fourth permanent magnets, and the permanent magnet embedding grooves are spaced apart outward from the first permanent magnets and the second permanent magnets at predetermined distances.

The permanent magnet embedding groove may have a predetermined length and a predetermined thickness, and the thickness of the permanent magnet embedding groove may be 4 mm to 7.5 mm.

The permanent magnet embedding groove may have a predetermined length and a predetermined thickness, and an output, torque, and efficiency of the permanent magnet motor may be controlled based on a change in thickness of the permanent magnet embedding groove.

With the above-mentioned configurations, the present invention has an effect in that the amount of usage of the permanent magnets is markedly reduced during the process of manufacturing the motor, such that material costs are reduced, working time required to embed the permanent magnets is reduced, and working time is greatly reduced.

The present invention has an effect in that even though the amount of usage of the permanent magnets is markedly reduced, a reduction rate of an output is very low, costs are reduced, the number of working processes is reduced, and assembly workability is improved.

### BRIEF DESCRIPTION OF THE DRAWINGS

FIG. 1 is a view illustrating a configuration of a multilayered motor according to a first exemplary embodiment of the present invention;

FIG. 2 is an enlarged view of a partial region of the multilayered motor according to the first exemplary embodiment of the present invention;

FIG. 3 is a view illustrating a configuration of a multilayered motor for reducing the amount of usage of permanent magnets according to a second exemplary embodiment of the present invention;

FIG. 4 is an enlarged view of a partial region of the multilayered motor according to the second exemplary embodiment of the present invention; and

FIG. 5 is a graph illustrating characteristic values with respect to a change in thickness of a permanent magnet embedding groove according to the second exemplary embodiment of the present invention.

### DETAILED DESCRIPTION

Throughout the specification, unless explicitly described to the contrary, the word “comprise/include” and variations such as “comprises/includes” or “comprising/including” will be understood to imply the inclusion of stated elements but not the exclusion of any other elements.

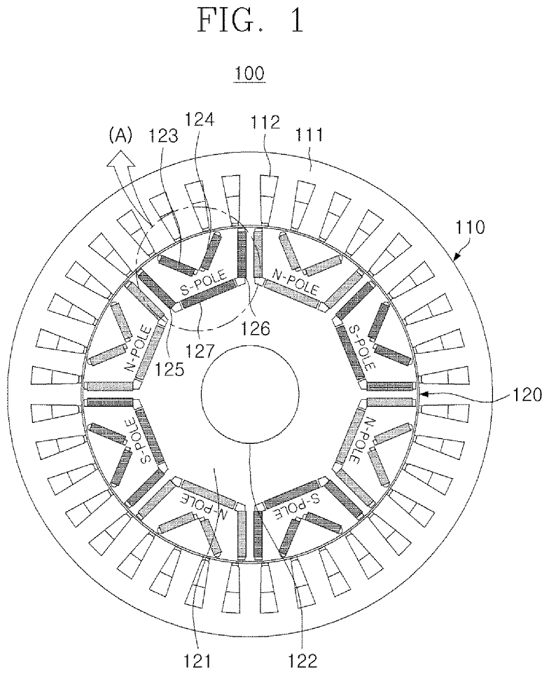

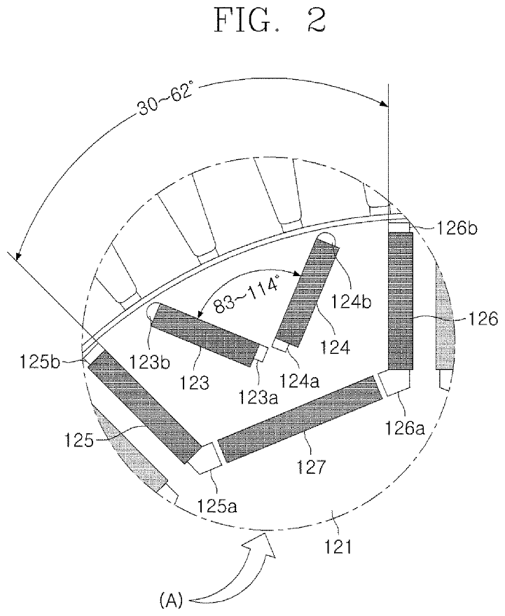

FIG. 1 is a view illustrating a configuration of a multilayered motor according to a first exemplary embodiment of the present invention, and FIG. 2 is an enlarged view of a partial region of the multilayered motor according to the first exemplary embodiment of the present invention.

A multilayered motor 100 according to the first exemplary embodiment of the present invention includes a stator 110 and a rotor 120 disposed in the stator 110.

The stator 110 has a stator core 111 and stator slots 112 that surround the rotor 120.

The rotor 120 has one or more permanent magnets disposed in multiple layers on a rotor core 121 so that motor poles are alternately disposed, thereby defining N-pole magnets and S-pole magnets.

The multiple layers include a first layer in which first permanent magnets 123 and second permanent magnets 124 are provided in a V shape and spaced apart from the central axis 122 at a predetermined distance, and a second layer in which third permanent magnets 125 are arranged in a first direction from the central axis 122, fourth permanent magnets 126 are arranged in a second direction from the central axis 122, fifth permanent magnets 127 are arranged in a horizontal direction between ends of the third permanent magnets 125 and ends of the fourth permanent magnets 126, and the third permanent magnets 125, the fourth permanent magnets 126, and the fifth permanent magnets 127 are spaced apart outward from the first permanent magnets 123 and the second permanent magnets 124 at predetermined distances.

The rotor 120 has 8 motor poles, and motor poles each including the first permanent magnet 123, the second permanent magnet 124, the third permanent magnet 125, the fourth permanent magnet 126, and the fifth permanent magnet 127 are alternately disposed as N-poles and S-poles.

An angle between the first permanent magnet 123 and the second permanent magnet 124 is 83 degrees to 114 degrees.

An angle between the third permanent magnet 125 and the fourth permanent magnet 126 is 30 degrees to 62 degrees about a central axis 122 of the rotor 120, such that the angle is increased as a distance from the central axis 122 is increased.

The fifth permanent magnet 127 is disposed in the horizontal direction to be spaced apart from the third permanent magnet 125 and the fourth permanent magnet 126 at predetermined distances and disposed between one end of the third permanent magnet 125 and one end of the fourth permanent magnet 126, and one end of the third permanent magnet 125 and one end of the fourth permanent magnet 126 are closest to the central axis 122 of the rotor 120.

To reduce a leakage of magnetic flux, magnetic flux leakage prevention holes 123a, 123b, 124a, 124b, 125a, 125b, 126a, and 126b are formed at both ends of each of the first permanent magnet 123, the second permanent magnet 124, the third permanent magnet 125, and the fourth permanent magnet 126, and the magnetic flux leakage prevention holes define spaces through which no magnetic flux passes.

A thickness of each of the first permanent magnet 123, the second permanent magnet 124, the third permanent magnet 125, and the fourth permanent magnet 126 may be 3.0 mm to 4.5 mm.

Bridges (not illustrated) are formed in a space where the magnetic flux leakage prevention hole 123a and the magnetic flux leakage prevention hole 124a are spaced apart from each other at a predetermined distance, a space where the magnetic flux leakage prevention hole 125a and the fifth permanent magnet 127 are spaced apart from each other at a predetermined distance, a space where the magnetic flux leakage prevention hole 126a and the fifth permanent magnet 127 are spaced apart from each other at a predetermined distance, and spaces between the magnetic flux leakage prevention holes 125b, 123b, 124b, and 126b and the stator core 111. The bridges minimize a leakage of magnetic flux by forming magnetic flux barriers that make it difficult for the magnetic flux released from the permanent magnets to be discharged.

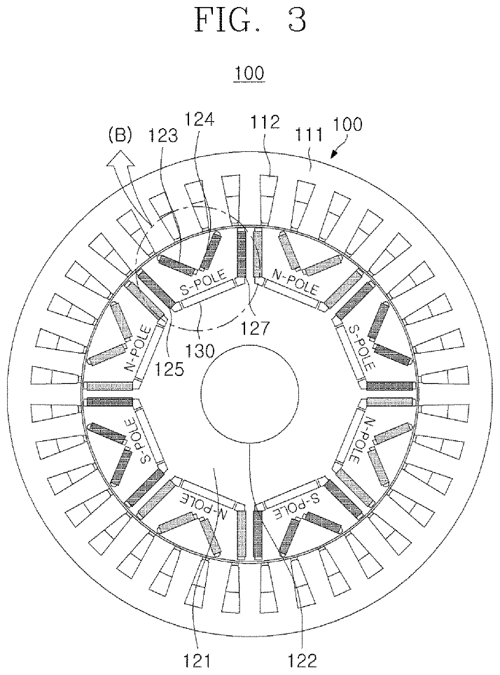

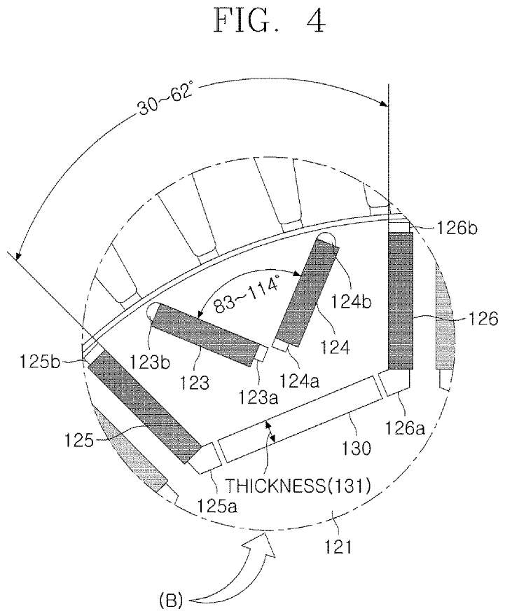

FIG. 3 is a view illustrating a configuration of a multilayered motor for reducing the amount of usage of permanent magnets according to a second exemplary embodiment of the present invention, and FIG. 4 is an enlarged view of a partial region of the multilayered motor according to the second exemplary embodiment of the present invention.

A multilayered motor 100 for reducing the amount of usage of permanent magnets according to the second exemplary embodiment of the present invention will be described, focusing on differences between the first exemplary embodiment and the second exemplary embodiment, with the omission of the description of constituent elements identical to the constituent elements described in the first exemplary embodiment.

The multilayered motor 100 according to the second exemplary embodiment of the present invention includes a stator 110 and a rotor 120 disposed in the stator 110, and the rotor 120 has one or more permanent magnets disposed in multiple layers on a rotor core 121 so that motor poles are alternately disposed, thereby defining N-pole magnets and S-pole magnets.

The multiple layers include a first layer in which first permanent magnets 123 and second permanent magnets 124 are provided in a V shape and spaced apart from the central axis 122 at a predetermined distance, and a second layer in which third permanent magnets 125 are arranged in a first direction from the central axis 122, fourth permanent magnets 126 are arranged in a second direction from the central axis 122, permanent magnet embedding grooves 130 are formed in a horizontal direction between ends of the third permanent magnets 125 and ends of the fourth permanent magnets 126, the permanent magnet embedding grooves 130 are vacant spaces in which no fifth permanent magnet 127 is embedded, and the third permanent magnets 125, the fourth permanent magnets 126, and the permanent magnet embedding grooves 130 are spaced apart outward from the first permanent magnets 123 and the second permanent magnets 124 at predetermined distances.

The rotor 120 according to the second exemplary embodiment is structured to have the vacant spaces in which no fifth permanent magnet 127 according to the first exemplary embodiment is embedded.

In the second exemplary embodiment, the fifth permanent magnet according to the first exemplary embodiment is not used, such that the amount of usage of the permanent magnets is reduced, costs are reduced, and assembly workability of the permanent magnets is improved.

The following Table 1 shows a result of comparing the first exemplary embodiment and the second exemplary embodiment in terms of change in outputs, torque, and efficiency of the motors 100 under the same condition.

TABLE 1

| | FIRST | SECOND | | |
|---|---|---|---|---|
| | EXEMPLARY | EXEMPLARY | | |
| | EMBODIMENT | EMBODIMENT | COMPARISON | REMARKS |
| AMOUNT OF | 2.68 | 2.055 | DECREASED | CONDITION |
| USAGE OF | | | BY 22.2% | 1. SPEED: 3400 rpm |
| MAGNET (kg) | | | | 2. TORQUE ANGLE: 48° |
| POWER(kW) | 106.23 | 99.7 | DECREASED | 3. CURRENT: 318A |
| | | | BY 6.1% | |
| OUTPUT/AMOUNT | 39.64 | 48.52 | INCREASED | |
| OF USAGE OF | | | BY 22.38% | |
| MAGNET(kW/kg) | | | | |
| TORQUE(Nm) | 298.37 | 280.02 | DECREASED | |
| | | | BY 6.1% | |
| EFFICIENCY(%) | 94.774 | 94.37 | DECREASED | |
| | | | BY 0.4% | |

As shown in Table 1, it can be seen that the amount of usage of the permanent magnets is decreased by 22.2%, the output is decreased by 6.1%, the efficiency is decreased by 0.4%, and the output with respect to the amount of usage of the magnets is increased by 22.38% in the second exemplary embodiment in comparison with the first exemplary embodiment.

It can be seen that the number of permanent magnets for each motor pole is decreased from five to four, and the number of working processes is decreased by 20%.

This result shows that there is an effect in that even though the amount of usage of the permanent magnets is markedly reduced, a reduction rate of output is very low, costs are reduced, the number of working processes is reduced, and assembly workability is improved.

In the rotor 120 according to the second exemplary embodiment, a thickness A of the permanent magnet embedding groove 130, which is the vacant space in which no fifth permanent magnet 127 is embedded, is changed, such that characteristic values of the output, the torque, and the efficiency of the motor 100 are changed.

The following Table 2 shows a result of simulation performed on changes in output, torque, and efficiency of the motor 100 with respect to the change in thickness of the permanent magnet embedding groove 130.

TABLE 2

| THICKNESS(131) | POWER(kW) | TORQUE(Nm) | EFFOY(%) |
|---|---|---|---|
| 0 | 54.297 | 152.5 | 90.26 |
| 1 | 83.66 | 234.97 | 93.425 |
| 1.5 | 89.699 | 251.93 | 93.817 |
| 2 | 93.399 | 262.32 | 94.003 |
| 2.5 | 95.849 | 269.2 | 94.168 |
| 3 | 97.494 | 273.82 | 94.256 |
| 3.5 | 98.774 | 277.42 | 94.322 |
| 4 | 99.701 | 280.02 | 94.37 |
| 4.4 | 100.28 | 281.65 | 94.399 |
| 5 | 100.9 | 283.39 | 94.43 |
| 5.5 | 101.28 | 284.45 | 94.448 |
| 6 | 101.54 | 285.2 | 94.462 |
| 6.5 | 101.73 | 285.73 | 94.472 |
| 7 | 101.84 | 286.03 | 94.478 |
| 7.5 | 101.91 | 286.22 | 94.482 |
| 8 | 101.9 | 286.2 | 94.482 |
| 8.5 | 101.81 | 285.96 | 94.479 |
| 9 | 101.67 | 285.56 | 94.473 |
| 9.5 | 101.48 | 285.01 | 94.465 |
| 10 | 101.28 | 284.46 | 94.456 |
| 10.5 | 101.01 | 283.7 | 94.444 |
| 11 | 100.6 | 283.1 | 94.434 |
| 11.5 | 100.48 | 282.21 | 94.419 |
| 12 | 100.21 | 281.45 | 94.407 |

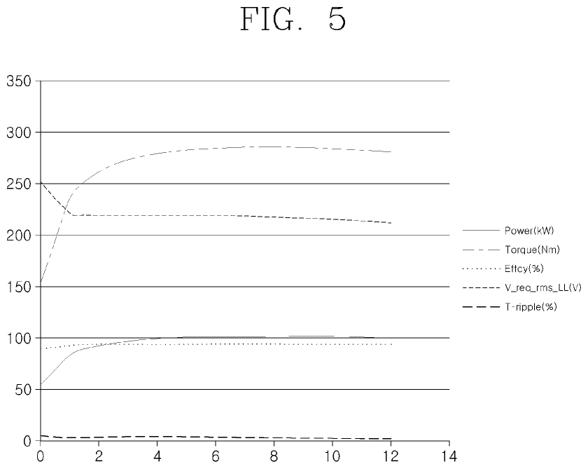

FIG. 5 is a graph illustrating characteristic values with respect to the change in thickness of the permanent magnet embedding groove 130 in accordance with the result shown in Table 2.

As illustrated FIG. 5 and shown in Table 2, it can be seen that the characteristic values of the output, the torque, and the efficiency of the motor 100 are increased when the thickness of the permanent magnet embedding groove 130 is 4 mm or more.

However, it can be seen that the characteristic values of the output, the torque, and the efficiency of the motor 100 are decreased as the thickness of the permanent magnet embedding groove 130 is greater than 7.5 mm.

When the thickness of the permanent magnet embedding groove 130 of the motor 100 is 7.5 mm, the output is 101.91 kW, the torque is 286.22 Nm, and the efficiency is 94.482%. The output is decreased by 4.06%, and the efficiency is decreased by 0.3% in comparison with the first exemplary embodiment in which the output is 106.23 kW and the efficiency is 94.774%.

It is possible to obtain an optimum dimension of the permanent magnet embedding groove 130, which is the vacant space in which no permanent magnet is used, by decreasing the amount of usage of the magnets of the motor 100, and the optimum dimension is made when the output, the torque, and the efficiency of the motor 100 with respect to the change in thickness of the permanent magnet embedding groove 130 are best.

As shown in Table 2, it can be ascertained that the optimum dimension of the permanent magnet embedding groove 130 is 7.5 mm.

The permanent magnet embedding groove 130 has a predetermined length and a predetermined thickness. The thickness of the permanent magnet embedding groove 130 may be about 4 mm to about 7.5 mm, and particularly, the thickness of the permanent magnet embedding groove 130 is 7.5 mm.

The thickness of the permanent magnet embedding groove 130 is greater than a thickness of each of the first permanent magnet 123, the second permanent magnet 124, the third permanent magnet 125, and the fourth permanent magnet 126.

With the above-mentioned result, it can be seen that even though the amount of usage of the permanent magnets is markedly reduced in the second exemplary embodiment, a reduction rate of output or efficiency is very low, the effect of reducing costs is increased, and the effect of reducing the number of working processes and improving assembly workability is increased.

The foregoing exemplary embodiments of the present invention are not implemented only by an apparatus and a method. Based on the above-mentioned descriptions of the exemplary embodiments, those skilled in the art to which the present invention pertains may easily realize the exemplary embodiments through programs for realizing functions corresponding to the configuration of the exemplary embodiment of the present invention or recording media on which the programs are recorded.

Although examples of the present invention have been described in detail hereinabove, the right scope of the present invention is not limited thereto, and it should be clearly understood that many variations and modifications of those skilled in the art using the basic concept of the present invention, which is defined in the following claims, will also belong to the right scope of the present invention.

What is claimed is:

1. A rotor for a permanent magnet motor, the rotor being disposed in a stator and having one or more permanent magnets disposed in multiple layers so that motor poles are alternately disposed to define N-pole magnets and S-pole magnets,
wherein the multiple layers comprise:
a first layer in which first permanent magnets and second permanent magnets are provided in a V shape and spaced apart from a central axis at a predetermined distance; and
a second layer in which third permanent magnets are arranged in a first direction from the central axis, fourth permanent magnets are arranged in a second direction from the central axis, permanent magnet embedding grooves are formed in a horizontal direction between ends of the third permanent magnets and ends of the fourth permanent magnets, the permanent magnet embedding grooves are vacant spaces in which no permanent magnet is embedded, and the third permanent magnets, the fourth permanent magnets, and the permanent magnet embedding grooves are spaced apart outward from the first permanent magnets and the second permanent magnets at predetermined distances.

2. The rotor of claim 1, wherein the permanent magnet embedding groove has a predetermined length and a predetermined thickness, and the thickness of the permanent magnet embedding groove is 4 mm to 7.5 mm.

3. The rotor of claim 1, wherein the permanent magnet embedding groove has a predetermined length and a predetermined thickness, and an output, torque, and efficiency of the permanent magnet motor are controlled based on a change in thickness of the permanent magnet embedding groove.

4. The rotor of claim 1, wherein an angle between the third permanent magnet and the fourth permanent magnet is 30 degrees to 62 degrees about the central axis of the rotor, the angle is increased as a distance from the central axis is increased, and an angle between the first permanent magnet and the second permanent magnet is 83 degrees to 114 degrees.

5. The rotor of claim 1, wherein a thickness of the permanent magnet embedding groove is greater than a thickness of each of the first permanent magnet, the second permanent magnet, the third permanent magnet, and the fourth permanent magnet.

6. The rotor of claim 1, wherein magnetic flux leakage prevention holes, which are spaces through which no magnetic flux passes, are formed at both ends of each of the first permanent magnet, the second permanent magnet, the third permanent magnet, and the fourth permanent magnet to reduce a leakage of magnetic flux.
